(19) United States
(12) Patent Application Publication
(10) Pub. No.: US 2024/0405862 A1
(43) Pub. Date: Dec. 5, 2024

(54) MULTIPATH REPEATER SYSTEMS

(71) Applicant: Pivotal Commware, Inc., Bothell, WA (US)

(72) Inventor: Eric James Black, Bothell, WA (US)

(21) Appl. No.: 18/599,692

(22) Filed: Mar. 8, 2024

Related U.S. Application Data
(63) Continuation of application No. 17/859,632, filed on Jul. 7, 2022, now Pat. No. 11,929,822.
(60) Provisional application No. 63/219,318, filed on Jul. 7, 2021.

(51) Int. Cl. H04B 7/204; H04B 7/0413; H04B 7/155

(52) U.S. Cl. CPC H04B 7/2041; H04B 7/0413; H04B 7/15592

(57) ABSTRACT

A wireless communication network such as a 5G communication network can use MIMO technologies to enhance bandwidth between a wireless communications base station and one or more user equipment devices within a service area of the base station. RF signal repeaters can be utilized to provide one or more additional physical channels for communication between the MIMO base station and the MIMO user equipment. These RF signal repeaters can be regarded as increasing the MIMO channel diversity within the ambient environment.

### CROSS-REFERENCE TO RELATED APPLICATION

This Utility Patent Application is a Continuation of U.S. patent application Ser. No. 17/859,632 filed on Jul. 7, 2022, now U.S. Pat. No. 11,929,822 issued on Mar. 12, 2024, which is based on previously filed U.S. Provisional Patent Application No. 63/219,318 filed on Jul. 7,2021, the benefit of the filing date of which is hereby claimed under 35 U.S.C. § 119 (e) and § 120,and the contents of which are each further incorporated in entirety by reference.

### TECHNICAL FIELD

This invention relates generally to employing RF signal repeaters to improve MIMO communications within a wireless communications network such as a 5G communications network operating at FR1 or FR2 frequency bands.

BACKGROUND

Wireless communications networks may employ MIMO technologies to enhance bandwidth between a wireless communications base station and one or more user equipment devices within a service area of the base station. The wireless communications networks can include, for example, 5G communications networks, which typically operate in two frequency bands indicated as “FR1” and “FR2.” FR1 roughly corresponds to frequencies below7.125 GHz, and FR2 corresponds to “millimeter wave” frequencies above 24.25 GHz.

In a MIMO scenario, a MIMO base station can include multiple transmitter radio chains capable of transmitting multiple data streams over multiple spatial layers, and each MIMO user equipment device can include multiple receiver radio chains capable of receiving those multiple data streams simultaneously over the multiple spatial layers. Generally speaking, if a MIMO base station provides M transmit radio chains, and a single MIMO user equipment device provides N receive radio chains, the system nominally supports communication between the MIMO base station and the single user equipment over a number of layers equal to min (M,N). To enhance bandwidth for this communication between the MIMO base station and the single user equipment, the base station attempts to allocate each layer to a separate “channel” which corresponds to a physical transmission path from the base station to the user equipment through the intervening environment. For example, one transmission path might be a direct line-of-sight propagation of an RF signal from the base station to the user equipment, while second, third, etc. transmission paths might correspond to multipath or non-line-of-sight propagation of RF signals from the base station to the user equipment, e.g. due to one or more reflections from structures within the intervening environment.

In practice, the number of actual or usable spatial layers can be less than the nominal number of spatial layers min (M,N). This can occur if the intervening environment does not provide an orthogonal set of suitable physical channels that can be allocated to the MIMO spatial layers. Thus, for example, in a preferred but impractical scenario where a base station and a user equipment device are enclosed within a shield room with metallic non-absorbing walls, the shield room provides a multipath-rich environment by virtue of reflections from the walls, and channels may be available for all or most nominal spatial layers. On the other hand, tests within anechoic chambers or within real-world environments often show not more than two usable spatial layers corresponding to two orthogonal RF polarizations for line-of-sight transmission between base station and user equipment. This is due to the typical absence of suitable ambient reflective structures within the intervening environment.

### BRIEF DESCRIPTION OF THE DRAWINGS

FIG. 1 depicts a MIMO communications system that includes a MIMO base station, a repeater, and a MIMO user equipment device.

FIGS. 2-4 depict process flows.

### DESCRIPTION OF VARIOUS EMBODIMENTS OF THE INVENTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Similarly, the phrase “in another embodiment” as used herein does not necessarily refer to a different embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments of the invention provide for enhanced MIMO communication between a MIMO base station and a MIMO user equipment device by providing additional paths for communication between base station and user equipment through one or more RF signal repeaters. As discussed above, real-world environments often show not more than two usable spatial layers corresponding to two orthogonal RF polarizations for line-of-sight transmission between base station and user equipment, and this is due to the common shortage of suitable ambient reflective structures within the ambient environment between and surrounding the base station and user equipment. Embodiments of the invention employ RF signal repeaters to provide one or more additional physical channels for communication between the MIMO base station and the MIMO user equipment. These RF signal repeaters can be regarded as increasing the channel diversity within the ambient environment. Rather than depending on chance to provide the needed channel diversity, the channel can now be engineered to force the existence of additional spatial layers. In some approaches, this technique can be utilized for “hotspot” quenching, i.e., to provide additional channel diversity for communication between the MIMO base station and a high density of user equipment devices for a particular region within the service area of the MIMO base station.

### Illustrative MIMO Communication System

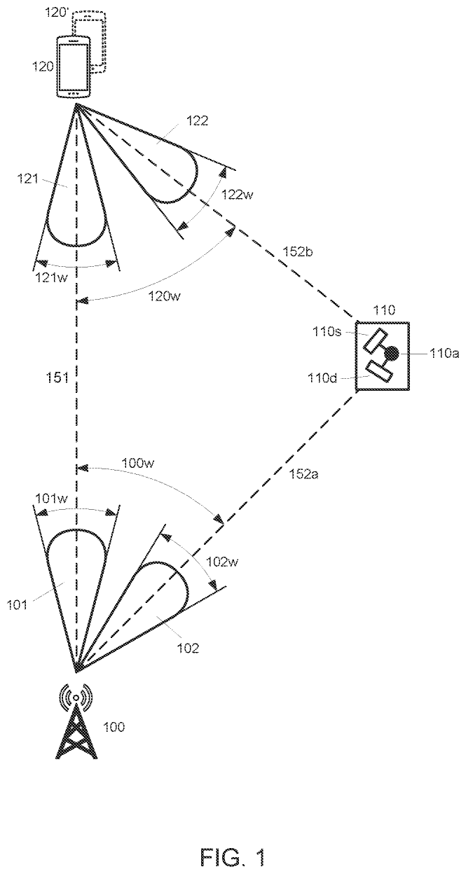

With reference now to FIG. 1, an illustrative MIMO scenario is depicted. In this scenario, a MIMO base station 100 communicates with MIMO user equipment 120, and multipath MIMO communication is facilitated by the RF repeater 110.

The MIMO base station 100 can be, for example, a 5G MIMO gNB base station for FRI or FR2 communications with recipients within a coverage area of the base station. In other embodiments, the MIMO base station 100 can be a 4G MIMO eNB base station. These are non-limiting examples and embodiments are contemplated for any wireless communications protocols that are compatible with MIMO communications principles.

In the illustrative example, the MIMO base station 100 communicates with the MIMO user equipment 120 using at least two MIMO spatial channels: a first MIMO spatial channel corresponding to a first path 151 between the base station 100 and the user equipment 120, and a second MIMO spatial channel corresponding to a second path 152 having two segments 152a and 152b. Segment 152a of the second path is a path between the MIMO base station 100 and the RF repeater 110, while segment 152b of the second path is a path between the RF repeater 110 and user equipment 120. Thus, in the illustrative example, the first path 151 is a line-of-sight path between base station 100 and user equipment 120, while the second path 152a, 152b is a non-line-of-sight path between base station 100 and user equipment 120 via the RF repeater 110.

The MIMO base station can distinguish separate spatial channels for the separate paths 151, 152 by having one or more beamforming antennas with sufficient angular resolution. For example, the MIMO base station can provide a first beam 101 having beamwidth 101w along path 151 (i.e., in the direction of the user equipment 110), and a second beam 102 having beamwidth 102w along path 152a (i.e., in the direction of the RF repeater 110). The spatial channels are distinguishable if the subtended angle 100w between the user equipment 120 and the RF repeater 110, as viewed from the base station 100, exceeds the beamwidths 101w, 102w of the beams 101, 102 facing the user equipment 120 and RF repeater 110, respectively.

In some approaches, the one or more beamforming antennas of the MIMO base station 100 can include one or more array antennas. A typical array antenna might be an array of elements forming a physical aperture having an area Mλ×Nλ, where λ is a wavelength corresponding to an operating frequency of the communications system and M and N are numbers greater than or equal to 1. M and N can be integers, half-integers, or other fractional numbers. The beamforming capability then depends on the overall dimensions of the array antenna. For example, a 4λ×4λ aperture would provide an angular resolution of about 12°.

Regarding the MIMO communication from the user equipment side, the MIMO user equipment 120 can similarly distinguish separate the spatial channels for the separate paths 151, 152 by having one or more beamforming antennas with sufficient angular resolution. For example, the MIMO user equipment can provide a first beam 121 having beamwidth 121w along path 151 (i.e., in the direction of the base station 100), and a second beam 122 having beamwidth 122w along path 152b (i.e., in the direction of the RF repeater 110). The spatial channels are distinguishable if the subtended angle 120w between the base station 100 and the RF repeater 110, as viewed from the user equipment 120, exceeds the beamwidths 121w, 122w of the beams 121, 122 cast towards the base station 100 and RF repeater 110, respectively.

In some approaches, the one or more beamforming antennas of the MIMO user equipment 120 can include one or more array antennas. A typical array antenna might be an array of elements forming a physical aperture having an area Mλ×Nλ, where λ is a wavelength corresponding to an operating frequency of the communications system and M and N are numbers greater than or equal to 1. M and N can be integers, half-integers, or other fractional numbers. For example, a 4λ×4λ aperture would provide an angular resolution of about 12°. In some scenarios, the MIMO user equipment might be fixed wireless equipment with a relatively larger aperture providing higher angular resolution for distinguishing spatial channels, while in other scenarios, the MIMO user equipment might be a smaller device such as a mobile phone; in the latter case, the angular separation 120w may need to be 90° or larger.

In the illustrative scenario of FIG. 1, the RF repeater 110 is a device that is installed on a structure 110a, which might be a post, pole, building corner, or any other structure suitable for installation of an RF repeater. The RF repeater is configured to receive signals from base station 100 and rebroadcast the received signals to the user equipment 120. The repeater can include a donor antenna (e.g., 110d) providing a beam that points at the base station 100, and a service antenna (e.g., 110s) providing a beam that covers a rebroadcast service area, e.g., including the user equipment 120 The donor antenna and/or the service antenna can be electronically adjustable antennas such as holographic beamforming antennas. Various RF repeater structures are described, for example, in U.S. Pat. No. 10,425,905, which is herein incorporated by reference.

While the illustrative example of FIG. 1 depicts two spatial channels 151 and 152, where the first channel 151 is a line-of-sight channel and the second channel 152 is a non-line of sight channel directed through repeater 110, in other embodiments, both channels can be non-line-of-sight. For example, the first channel can be a reflected by an ambient reflective structure within the environment, or the first channel can be directed through a second repeater, not shown. In yet other embodiments, the MIMO communication between the base station 100 and the user equipment 120 can occur over three channels, where the first is a line-of-sight channel corresponding to path 151, the second is a non-line-of-sight channel corresponding to path 152a, 152b by way of repeater 110, and the third is a non-line-of-sight channel (not shown) corresponding to a third path by way of another repeater.

In some approaches, more than one user equipment device may be substantially co-located within a region and embodiments employ MIMO techniques to provide “hotspot quenching” to increase bandwidth for these substantially co-located user equipment devices. In the illustrative scenario of FIG. 1, two user equipment devices 120, 120′ may be co-located at an intersection of the first path 151 and the second path 152b. Thus, either or both of the user equipment devices 120, 120′ may have access to either or both of the first and second spatial layers supported by the first path 151 and second path 152b. For example, user equipment device 120 may utilize the first spatial layer for communication with the MIMO base station 100, while user equipment device 120′ may utilize the second spatial layer for communication with the MIMO base station 100.

### Illustrative Process Flows

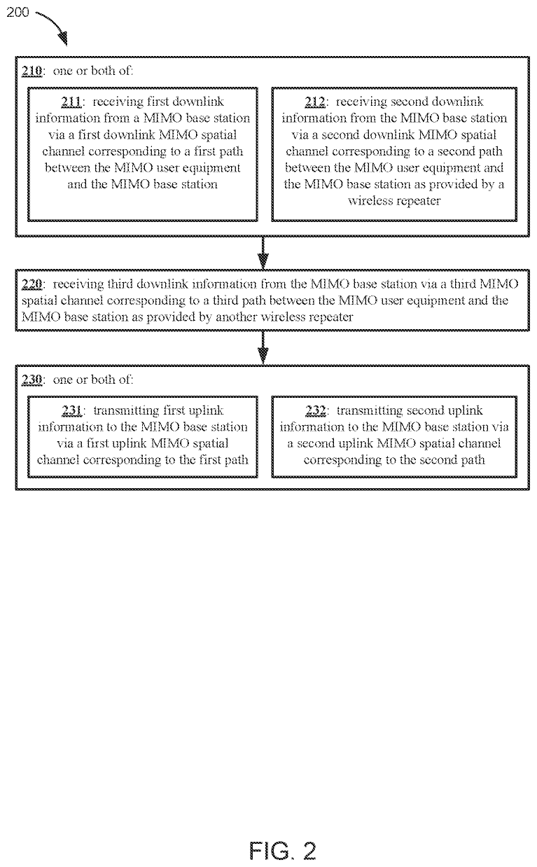

With reference now to FIG. 2, an illustrative embodiment is depicted as a process flow diagram. Process 200 is a process for operation of a MIMO user equipment device such as MIMO user equipment 120 or 120′ in FIG. 1. Process 200 includes operation 210-performing one or both of sub-operations 211 and 212. Sub-operation 211 is receiving first downlink information from a MIMO base station via a first downlink MIMO spatial channel corresponding to a first path between the MIMO user equipment and the MIMO base station. For example, in FIG. 1, MIMO user equipment 120 can receive first downlink information via a first downlink MIMO spatial channel corresponding to first path 151. Sub-operation 212 is receiving second downlink information from the MIMO base station via a second downlink MIMO spatial channel corresponding to a second path between the MIMO user equipment and the MIMO base station as provided by a wireless repeater. For example, in FIG. 1, MIMO user equipment 120 can receive second downlink information via a second downlink MIMO spatial corresponding to the second path 152b. Alternatively, separate MIMO user equipment 120′ co-located at the intersection of first path 151 and second path 152b can receive the second downlink information via the second downlink MIMO spatial channel corresponding to the second path 152b.

Process 200 optionally further includes operation 220—receiving third downlink information from the MIMO base station via a third MIMO spatial channel corresponding to a third path between the MIMO user equipment and the MIMO base station as provided by another wireless repeater.

Process 200 optionally further includes operation 230—performing one or both of sub-operations 231 and 232. Sub-operation 231 is transmitting first uplink information to the MIMO base station via a first uplink MIMO spatial channel corresponding to the first path. For example, in FIG. 1, MIMO user equipment 120 can transmit first uplink information via a first uplink MIMO spatial channel corresponding to first path 151. Sub-operation 232 is transmitting second uplink information to the MIMO base station via a second uplink MIMO spatial channel corresponding to the second path. For example, in FIG. 1, MIMO user equipment 120 can transmit second uplink information via a second uplink MIMO spatial corresponding to the second path 152b. Alternatively, separate MIMO user equipment 120′ co-located at the intersection of first path 151 and second path 152b can transmit the second uplink information via the second uplink MIMO spatial channel corresponding to the second path 152b.

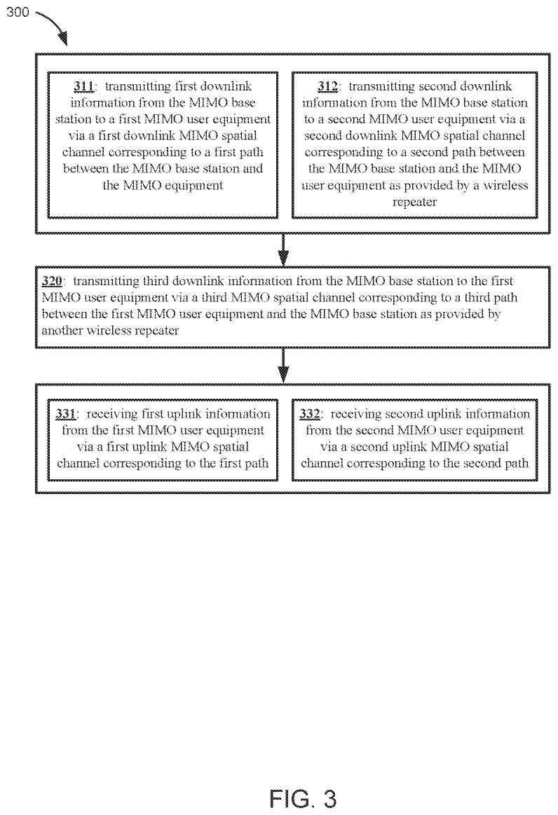

With reference now to FIG. 3, an illustrative embodiment is depicted as a process flow diagram. Process 300 is a process for operation of a MIMO base station such as MIMO base station 100 in FIG. 1. Process 300 includes operation 311—transmitting first downlink information from the MIMO base station to a first MIMO user equipment via a first downlink MIMO spatial channel corresponding to a first path between the MIMO base station and the MIMO equipment. For example, in FIG. 1, MIMO base station 100 can transmit downlink information to MIMO user equipment 120 via a first downlink MIMO spatial channel corresponding to a first path 151 between the MIMO base station 100 and the MIMO user equipment 120. Process 300 further includes operation 312—transmitting second downlink information from the MIMO base station to a second

MIMO user equipment via a second downlink MIMO spatial channel corresponding to a second path between the MIMO base station and the MIMO user equipment as provided by a wireless repeater. For example, in FIG. 1, MIMO base station 100 can further transmit second downlink information to the same MIMO user equipment 120 via a second downlink MIMO spatial channel corresponding to a second path 152a, 152b between the MIMO base station 100 and the MIMO user equipment 120 as provided by wireless repeater 110. Alternatively, MIMO base station 100 can transmit the second downlink information via the second downlink MIMO spatial channel corresponding to the second path 152a, 152b to a different MIMO user equipment 120′ co-located at the intersection of first path 151 and second path 152b.

Process 300 optionally further includes operation 320—transmitting third downlink information from the MIMO base station to the first MIMO user equipment via a third MIMO spatial channel corresponding to a third path between the first MIMO user equipment and the MIMO base station as provided by another wireless repeater.

Process 300 optionally further includes operation 331—receiving first uplink information from the first MIMO user equipment via a first uplink MIMO spatial channel corresponding to the first path. For example, in FIG. 1, MIMO base station 100 can receive uplink information from MIMO user equipment 120 via a first uplink MIMO spatial channel corresponding to a first path 151 between the MIMO base station 100 and the MIMO user equipment 120. Process 300 optionally further includes operation 332—receiving second uplink information from the second MIMO user equipment via a second uplink MIMO spatial channel corresponding to the second path.

For example, in FIG. 1, MIMO base station 100 can further receive second downlink information from the same MIMO user equipment 120 via a second downlink MIMO spatial channel corresponding to a second path 152a, 152b between the MIMO base station 100 and the MIMO user equipment 120 as provided by wireless repeater 110. Alternatively, MIMO base station 100 can receive the second uplink information via the second downlink MIMO spatial channel corresponding to the second path 152a, 152b from a different MIMO user equipment 120′ co-located at the intersection of first path 151 and second path 152b.

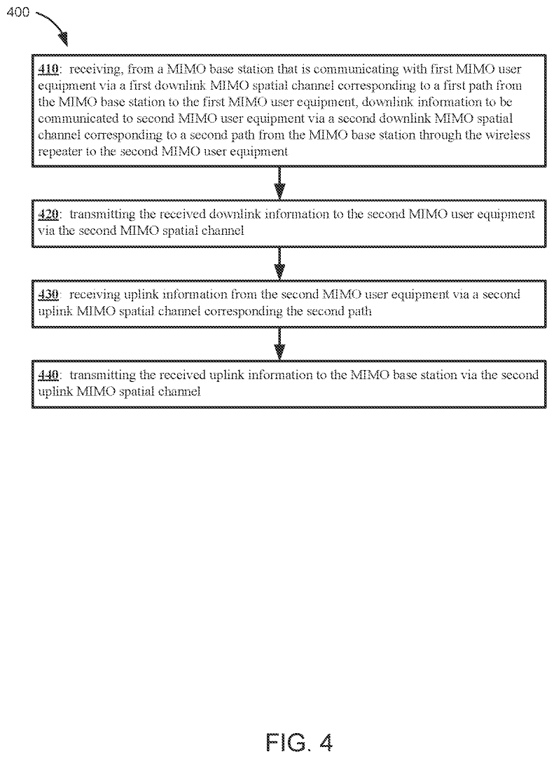

With reference now to FIG. 4, an illustrative embodiment is depicted as a process flow diagram. Process 400 is a process for operation of an RF repeater such as RF repeater 110 in FIG. 1. Process 400 includes operation 410—receiving, from a MIMO base station that is communicating with first MIMO user equipment via a first downlink MIMO spatial channel corresponding to a first path from the MIMO base station to the first MIMO user equipment, downlink information to be communicated to second MIMO user equipment via a second downlink MIMO spatial channel corresponding to a second path from the MIMO base station through the wireless repeater to the second MIMO user equipment; and operation 420—transmitting the received downlink information to the second MIMO user equipment via the second MIMO spatial channel. For example, in FIG. 1, repeater 110 can receive, from MIMO base station 100 that is communicating with MIMO user equipment 120 via a first downlink MIMO spatial channel corresponding to first path 151, downlink information to be communicated to the same MIMO user equipment 120 via a second downlink MIMO spatial channel corresponding to second path 152a, 152b. Alternatively, repeater 110 can receive, from MIMO base station 100 that is communicating with MIMO user equipment 120 via a first downlink MIMO spatial channel corresponding to first path 151, downlink information to be communicated to different MIMO user equipment 120′ via the second downlink MIMO spatial channel corresponding to second path 152a, 152b, where the user equipment 120, 120′ are co-located at the intersection of the first path 151 and the second path 152b.

Process 400 optionally further includes operation 430-receiving uplink information from the second MIMO user equipment via a second uplink MIMO spatial channel corresponding the second path; and operation 440—transmitting the received uplink information to the MIMO base station via the second uplink MIMO spatial channel. For example, in FIG. 1, the second MIMO user equipment can be the same MIMO user equipment 120 that is communicating with the MIMO base station via the first MIMO spatial channel corresponding to first path 121. Alternatively, in FIG. 1, the second MIMO user equipment can be different MIMO user equipment 120′ that is co-located with user equipment 120 at the intersection of the first path 151 and the second path 152b.

In one or more embodiments (not shown in the figures), a computing device may include one or more embedded logic hardware devices instead of one or more CPUs, such as, an Application Specific Integrated Circuits (ASICs), Field Programmable Gate Arrays (FPGAs), Programmable Array Logics (PALs), or the like, or combination thereof. The embedded logic hardware devices may directly execute embedded logic to perform actions. Also, in one or more embodiments (not shown in the figures), the computer device may include one or more hardware microcontrollers instead of a CPU. In one or more embodiments, the one or more microcontrollers may directly execute their own embedded logic to perform actions and access their own internal or memory and their own external Input and Output Interfaces (e.g., hardware pins and/or wireless transceivers) to perform actions, such as System On a Chip (SOC), external memory, or the like. Although not shown, the internal memory and/or the external memory may include one or more computer-readable storage media (CRM) devices for storage of information such as computer-readable instructions, data structures, program modules or other data. The CRM devices may provide for transitory and/or non-transitory storage of information. Additionally, in one or more embodiments, the computational resources may be distributed over a cloud computing platform and the like.

### Clauses for Various Embodiments Of The Invention

1. A method of operating MIMO user equipment, comprising one or both of:
receiving first downlink information from a MIMO base station via a first downlink MIMO spatial channel corresponding to a first path between the MIMO user equipment and the MIMO base station; and
receiving second downlink information from the MIMO base station via a second downlink MIMO spatial channel corresponding to a second path between the MIMO user equipment and the MIMO base station as provided by a wireless repeater.

2. The method of clause 1, wherein the method includes both the receiving of the first downlink information and the receiving of the second downlink information.

3. The method of clause 1, wherein the method includes the receiving of the first downlink information and does not include the receiving of the second downlink information.

4. The method of clause 1, wherein the method includes the receiving of the second downlink information and does not include the receiving of the first downlink information.

5. The method of clause 1, wherein the first path is a line-of-sight path and the second path is a non-line-of-sight path.

6. The method of clause 1, wherein the MIMO user equipment is mobile user equipment.

7. The method of clause 1, wherein the MIMO user equipment is a fixed wireless access (FWA) terminal.

8. The method of clause 1, wherein the MIMO base station is a 5G MIMO base station.

9. The method of clause 8, wherein the 5G MIMO base station is a 5G MIMO base station operating in a 5G FRI frequency band.

10. The method of clause 8, wherein the 5G MIMO base station is a 5G MIMO base station operating in a 5G FR2 frequency band.

11. The method of clause 1, wherein the MIMO base station is a 4G MIMO base station.

12. The method of clause 1, wherein the wireless repeater includes a donor antenna configured to receive the second downlink information from the MIMO base station and a service antenna configured to transmit the second downlink information to the MIMO user equipment.

13. The method of clause 12, wherein the donor antenna is an adjustable beamforming antenna.

14. The method of clause 13, wherein the adjustable beamforming antenna is a holographic beamforming antenna.

15. The method of clause 12, wherein the service antenna is an adjustable beamforming antenna.

16. The method of clause 15, wherein the adjustable beamforming antenna is a holographic beamforming antenna.

17. The method of clause 1, wherein: the MIMO user equipment includes a beamforming antenna system providing a selected angular resolution; and an angular separation between the first path and the second path is greater than the selected angular resolution.

18. The method of clause 17, wherein the selected angular resolution is less than 90°.

19. The method of clause 17, wherein the selected angular resolution is about 12°.

20. The method of clause 17, wherein the selected angular resolution is greater than or equal to 90°.

21. The method of clause 17, wherein the beamforming antenna system includes an array antenna having an aperture of Mλ×Nλ, where M is greater than 1, N is greater than or equal to 1, and λ is a wavelength corresponding to an operating frequency of the beamforming antenna system.

22. The method of clause 2, further comprising: receiving third downlink information from the MIMO base station via a third MIMO spatial channel corresponding to a third path between the MIMO user equipment and the MIMO base station as provided by another wireless repeater.

23. The method of clause 1, further comprising one or both of: transmitting first uplink information to the MIMO base station via a first uplink MIMO spatial channel corresponding to the first path; and transmitting second uplink information to the MIMO base station via a second uplink MIMO spatial channel corresponding to the second path.

24. The method of clause 23, wherein the method includes both the transmitting of the first uplink information and the transmitting of the second uplink information.

25. The method of clause 23, wherein the method includes the receiving of the first uplink information and does not include the transmitting of the second uplink information.

26. The method of clause 23, wherein the method includes the transmitting of the second uplink information and does not include the transmitting of the first uplink information.

27. The method of clause 23, wherein the first uplink MIMO spatial channel is equal to the first downlink MIMO spatial channel and the second uplink MIMO spatial channel is equal to the second downlink MIMO spatial channel.

28. A MIMO user equipment, comprising:
one or more processors coupled to one or more memories having instructions stored thereon to cause the MIMO user equipment to carry out the method of any of clauses 1-27.

29. A computer-readable medium storing instructions to cause a MIMO user equipment to carry out the method of any of clauses 1-27.

30. A method of operating a MIMO base station, comprising:
transmitting first downlink information from the MIMO base station to a first MIMO user equipment via a first downlink MIMO spatial channel corresponding to a first path between the MIMO base station and the MIMO equipment; and
transmitting second downlink information from the MIMO base station to a second MIMO user equipment via a second downlink MIMO spatial channel corresponding to a second path between the MIMO base station and the MIMO user equipment as provided by a wireless repeater.

31. The method of clause 30, wherein the second MIMO user equipment is the first MIMO user equipment.

32. The method of clause 30, wherein the first MIMO user equipment and the second MIMO user equipment are different MIMO user equipment co-located at an intersection of the first path and the second path.

33. The method of clause 30, wherein the first path is a line-of-sight path and the second path is a non-line-of-sight path.

34. The method of clause 30, wherein the first or second MIMO user equipment is mobile user equipment.

35. The method of clause 30, wherein the first or second MIMO user equipment is a fixed wireless access (FWA) terminal.

36. The method of clause 30, wherein the MIMO base station is a 5G MIMO base station.

37. The method of clause 36, wherein the 5G MIMO base station is a 5G MIMO base station operating in a 5G FR1 frequency band.

38. The method of clause 36, wherein the 5G MIMO base station is a 5G MIMO base station operating in a 5G FR2 frequency band.

39. The method of clause 30, wherein the MIMO base station is a 4G MIMO base station.

40. The method of clause 30, wherein:
the MIMO base station includes a beamforming antenna system providing a selected angular resolution; and
an angular separation between the first path and the second path is greater than the selected angular resolution.

41. The method of clause 40, wherein the selected angular resolution is less than or equal to 30°.

42. The method of clause 40, wherein the selected angular resolution is less than or equal to 15°.

43. The method of clause 40, wherein the selected angular resolution is less than or equal to 5°.

44. The method of clause 40, wherein the beamforming antenna system includes an array antenna having an aperture of Mλ×Nλ, where M is greater than 1, N is greater than or equal to 1, and λ is a wavelength corresponding to an operating frequency of the beamforming antenna system.

45. The method of clause 30, wherein the wireless repeater includes a donor antenna configured to receive the second downlink information from the MIMO base station and a service antenna configured to transmit the second downlink information to the second MIMO user equipment.

46. The method of clause 45, wherein the donor antenna is an adjustable beamforming antenna.

47. The method of clause 46, wherein the adjustable beamforming antenna is a holographic beamforming antenna.

48. The method of clause 45, wherein the service antenna is an adjustable beamforming antenna.

49. The method of clause 48, wherein the adjustable beamforming antenna is a holographic beamforming antenna.

50. The method of clause 30, further comprising:
transmitting third downlink information from the MIMO base station to the first MIMO user equipment via a third MIMO spatial channel corresponding to a third path between the first MIMO user equipment and the MIMO base station as provided by another wireless repeater.

51. The method of clause 30, further comprising:
receiving first uplink information from the first MIMO user equipment via a first uplink MIMO spatial channel corresponding to the first path; and
receiving second uplink information from the second MIMO user equipment via a second uplink MIMO spatial channel corresponding to the second path.

52. The method of clause 51, wherein the second MIMO user equipment is the first MIMO user equipment.

53. The method of clause 51, wherein the first MIMO user equipment and the second MIMO user equipment are different MIMO user equipment co-located at an intersection of the first path and the second path.

54. The method of clause 51, wherein the first uplink MIMO spatial channel is equal to the first downlink MIMO spatial channel and the second uplink MIMO spatial channel is equal to the second downlink MIMO spatial channel.

55. A MIMO base station, comprising:
one or more processors coupled to one or more memories having instructions stored thereon to cause the MIMO base station to carry out the method of any of clauses 30-54.

56. A computer-readable medium storing instructions to cause a MIMO base station to carry out the method of any of clauses 30-54.

1-20. (canceled)

21. A method of operating a multiple input and multiple output (MIMO) base station, comprising:
transmitting first downlink information from the MIMO base station to a first MIMO user equipment via a first downlink MIMO spatial channel corresponding to a first path between the MIMO base station and the MIMO equipment; and
transmitting second downlink information from the MIMO base station to a second MIMO user equipment via a second downlink MIMO spatial channel corresponding to a second path between the MIMO base station and the MIMO user equipment as provided by a wireless repeater.

22. The method of claim 21, wherein the second MIMO user equipment is the first MIMO user equipment.

23. The method of claim 21, wherein the first MIMO user equipment and the second MIMO user equipment are different MIMO user equipment co-located at an intersection of the first path and the second path.

24. The method of claim 21, wherein the first path is a line-of-sight path and the second path is a non-line-of-sight path.

25. The method of claim 21, wherein the first or second MIMO user equipment is mobile user equipment.

26. The method of claim 21, wherein the first or second MIMO user equipment is a fixed wireless access (FWA) terminal.

27. The method of claim 21, wherein the MIMO base station is a fifth generation (5G) MIMO base station.

28. The method of claim 27, wherein the 5G MIMO base station is a 5G MIMO base station operating in a 5G Frequency Range 1 (FR1) frequency band.

29. The method of claim 27, wherein the 5G MIMO base station is a 5G MIMO base station operating in a 5G Frequency Range 2 (FR2) frequency band.

30. The method of claim 21, wherein the MIMO base station is a fourth generation (4G) MIMO base station.

31. The method of claim 21, wherein:
the MIMO base station includes a beamforming antenna system providing a selected angular resolution; and
an angular separation between the first path and the second path is greater than the selected angular resolution.

32. The method of claim 31, wherein the selected angular resolution is less than or equal to thirty degrees (30°).

33. The method of claim 31, wherein the selected angular resolution is less than or equal to fifteen degrees (15°).

34. The method of claim 31, wherein the selected angular resolution is less than or equal to five degrees (5°).

35. The method of claim 31, wherein the beamforming antenna system includes an array antenna having an aperture of Mλ×Nλ, where M is greater than 1, N is greater than or equal to 1, and λ is a wavelength corresponding to an operating frequency of the beamforming antenna system.

36. The method of claim 21, further comprising:
transmitting third downlink information from the MIMO base station to the first MIMO user equipment via a third MIMO spatial channel corresponding to a third path between the first MIMO user equipment and the MIMO base station as provided by another wireless repeater.

37. The method of claim 21, further comprising:
receiving first uplink information from the first MIMO user equipment via a first uplink MIMO spatial channel corresponding to the first path; and
receiving second uplink information from the second MIMO user equipment via a second uplink MIMO spatial channel corresponding to the second path.

38. The method of claim 37, wherein the second MIMO user equipment is the first MIMO user equipment.

39. The method of claim 37, wherein the first MIMO user equipment and the second MIMO user equipment are different MIMO user equipment co-located at an intersection of the first path and the second path.

40. The method of claim 37, wherein the first uplink MIMO spatial channel is equal to the first downlink MIMO spatial channel and the second uplink MIMO spatial channel is equal to the second downlink MIMO spatial channel.

41. A multiple input and multiple output (MIMO) base station, comprising:
one or more processors coupled to one or more memories having instructions stored thereon to cause the MIMO base station to carry out a method that includes:
transmitting first downlink information from the MIMO base station to a first MIMO user equipment via a first downlink MIMO spatial channel corresponding to a first path between the MIMO base station and the MIMO equipment; and
transmitting second downlink information from the MIMO base station to a second MIMO user equipment via a second downlink MIMO spatial channel corresponding to a second path between the MIMO base station and the MIMO user equipment as provided by a wireless repeater.

42. A computer-readable medium storing instructions to cause a multiple input and multiple output (MIMO) base station to carry out a method that includes:
transmitting first downlink information from the MIMO base station to a first MIMO user equipment via a first downlink MIMO spatial channel corresponding to a first path between the MIMO base station and the MIMO equipment; and
transmitting second downlink information from the MIMO base station to a second MIMO user equipment via a second downlink MIMO spatial channel corresponding to a second path between the MIMO base station and the MIMO user equipment as provided by a wireless repeater.
